(19) United States
(12) Patent Application Publication
(10) Pub. No.: US 2016/0326997 A1
(43) Pub. Date: Nov. 10, 2016

(54) LIFE OF INTAKE AIR HEATER

(71) Applicant: International Engine Intellectual Property Company, LLC, Lisle, IL (US)

(72) Inventors: Paul Gottemoller, Princeville, IL (US); Toan Ngo, North Riverside, IL (US)

(21) Appl. No.: 14/705,134

(22) Filed: May 6, 2015

(51) Int. Cl. F02M 35/10

(52) U.S. Cl. CPC F02M 35/10268

(57) ABSTRACT

Springs of an intake air heater of an internal combustion engine that are used to account for expansion of the intake air heating element are replaced by other appropriate materials with similar and additional properties. A first compliant material and a second compliant material allow for the expansion of the intake air heating element and each is designed in a way such that collection of soot within the intake air heater is reduced or prevented. By preventing the collection of soot in the intake air heater, the intake air heating element has room to expand, and therefore, does not buckle, thereby increasing the life span of the intake air heater.

### TECHNICAL FIELD

The present disclosure relates generally to the field of air heater systems for an air intake of an internal combustion engine.

### BACKGROUND

Motor vehicles are used throughout the world in a variety of climates. Many of the operating climates experience ambient temperatures significantly below 40 degree F. While the injected diesel fuel self-ignites from mixing with the hot compressed intake air in the combustion chamber, at low ambient temperatures, the temperature within the combustion chamber may not be high enough to ensure proper ignition of the injected diesel fuel. This results in issues with starting the engine in cold weather conditions, especially if the engine has been soaked for an extended time in a cold ambient condition.

Incomplete combustion of diesel fuel at low temperatures results in unburned hydrocarbons in the engine exhaust. These unburned hydrocarbons cause the undesirable phenomenon known as ‘white smoke’. The side effect of ‘white smoke’ is attributable to misfiring or incomplete combustion in some or all cylinders of an engine. White smoke is a respiratory and optical irritant and has an adverse effect on visibility. To avoid the issues of white smoke and engine cold starting, intake air heaters having electrically controlled heated elements have been added to the engine assembly upstream of the intake manifold to raise the temperature of the intake air to ensure proper ignition of the diesel fuel in the combustion chamber during cold start conditions.

The intake air heater is typically located in an environment that can get very dirty, especially in a diesel engine that uses Exhaust Gas Recirculation. This is because some of the soot that may be generated during combustion may be recirculated along with exhaust gases back into the intake manifold, which is typically downstream of the intake air heater. The soot may clog different components in the intake air heater which affects the performance and reduces the life of the intake air heater. There is a desire to improve the life and performance attributes of intake air heaters in diesel engines by reducing or preventing the deposition of soot.

### SUMMARY

Embodiments described herein relate to an intake air heater for use with an internal combustion engine that includes an intake air heating element for heating intake manifold air and a first insulating part and a second insulating part for securing the electrically controlled intake air heating element. The first insulating part and the second insulating part, in turn, is each secured by a first housing and a second housing, respectively. A first compliant material, capable of elastically responding to an applied force, is placed between the first insulating part and a first surface of the first housing and a second compliant material, capable of elastically responding to an applied force, is placed between the second insulating part and a first surface of the second housing.

Embodiments described herein, relate to a method of reducing or preventing the collection of soot around the intake air heating element of an intake air heater in an internal combustion system. The method comprises a control system for enabling and disabling the intake air heating element based on a coolant temperature, the first insulating part to protect the first housing from excessive heat and the second insulating part to protect the second housing from excessive heat respectively. The first compliant material operable to elastically respond to changes in size of the intake air heating element and prevent the accumulation of soot is fixed between the first insulating part and the first surface of the first housing and the second compliant material operable to elastically respond to changes in size of the intake air heating element and prevent the accumulation of soot is placed between the second insulating part and the first surface of the second housing. When accumulation of soot is reduced or prevented, the intake air heating element can expand without any buckling, thereby extending the life of the intake air heater. Other embodiments to reduce or prevent the collection of soot are possible.

### BRIEF DESCRIPTION OF THE DRAWINGS

FIG. 1 is a schematic block diagram of a portion of a diesel engine incorporating the EGR system and the intake manifold system;

FIG. 2 and FIG. 3 show a first embodiment of an Intake Air heater described herein;

FIG. 2A is a close-up side view of the first housing;

FIG. 4 shows the assembly of the Intake air heater in an engine;

FIG. 5 is a second embodiment of an Intake air heater described herein;

FIG. 6 is a third embodiment of an Intake air heater described herein;

FIG. 6A is a detailed representation of the spring assembly from FIG. 6

FIG. 7 is a fourth embodiment of an intake air heater described herein

### DETAILED DESCRIPTION

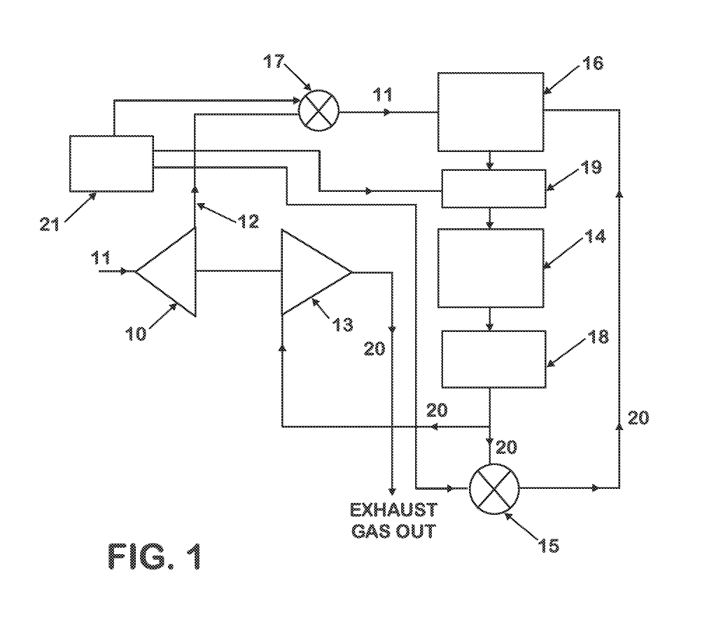

As is shown in FIG. 1, pressurized fresh engine intake air 11 is obtained from an engine mounted turbocharger compressor 10 and is carried to the engine cylinders (not shown) in the combustion chamber 18 by an air intake system line 12 to an air intake manifold 13. Exhaust gas 20 produced in the cylinders (not shown) upon combustion carries chemical constituents and soot. The amount of exhaust gas 20 to be recirculated is controlled by an exhaust gas recirculation system of the engine as described. In this embodiment, a predetermined portion of the exhaust gas 20 exiting the turbine 13 is reintroduced into the engine mixer 16 through the exhaust gas recirculation valve 15, which is electronically controlled by an engine control module, ECM 21, along with the fresh intake air 11 from the compressor 10 through the intake throttle valve 17, which is also electronically controlled by the ECM 21. The exhaust gas 20 and the fresh intake air 11 are mixed in the engine mixer 16 and travel to the intake manifold 14, from where this mixture of exhaust gas 20 and fresh intake air 11 is combusted again, in an attempt to reduce in-cylinder NOx generation. An intake air heater 19, electronically controlled by the ECM 21, is attached to the engine mixer 16 so that the exhaust gas 20 and fresh intake air 11 mixture travels through the intake air heater 19 before entering the air intake manifold 14.

Soot may form during incomplete fuel combustion. The intake air heater 19, downstream of the engine mixer 16 and upstream of the air intake manifold 14 in this embodiment, has a tendency to become fouled by the deposition of soot contained in the recirculated exhaust gas 20. The deposition of soot, combined with thermal expansion of the intake air heating element 22 in the intake air heater 19 when the intake air heating element 22 is activated compromises the efficiency of the intake air heater 19.

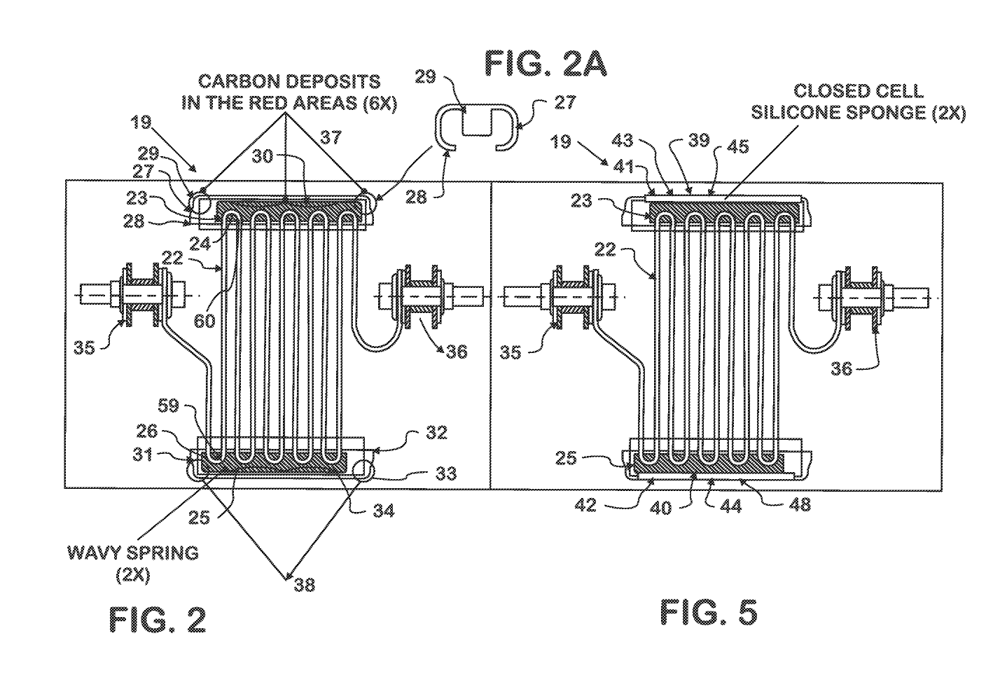

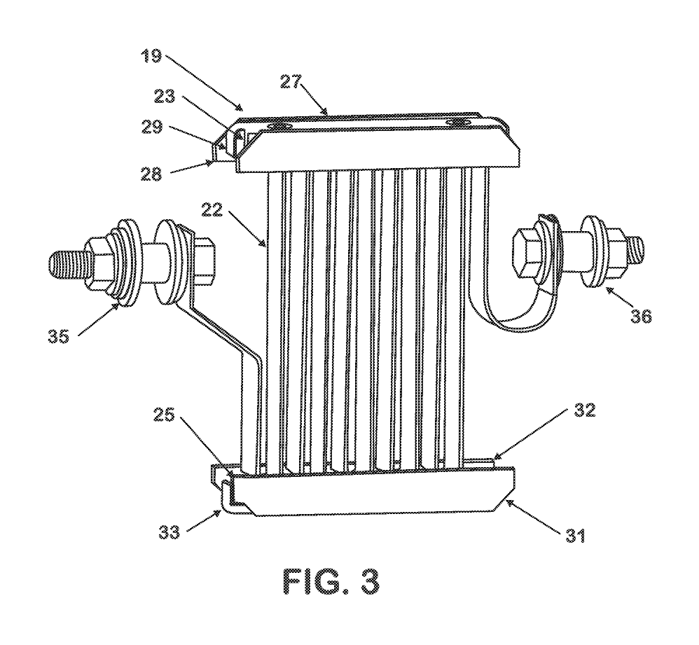

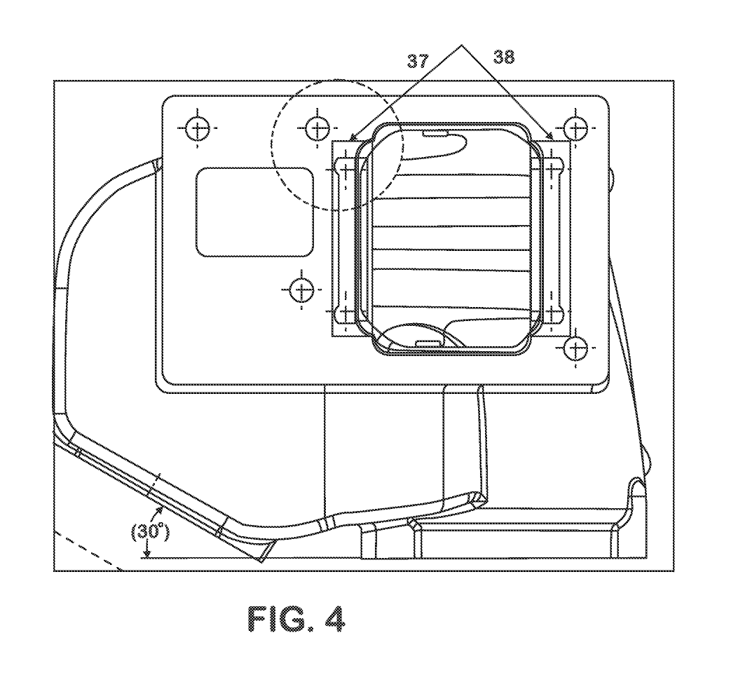

FIG. 2 and FIG. 3 show a detailed embodiment of the intake air heater 19. The intake air heater 19 constitutes one or more electrical intake air heating element 22, such as a ribbon type heating element with at least two folds, such as first fold 59 and second fold 60, arranged in a parallel configuration. Other configurations and arrangements of the folds are possible. As is known in the art, heating elements are typically made of nichrome, which is an alloy of Nickel and Chromium. Other materials, such as Iron alloys may also be used. The intake air heating element 22 is attached to a first insulating part 23 made from a material such as ceramic and designed to fit compatibly with the shape and features of the intake air heating element 22 along a first surface 24 and a second insulating part 25 made from a material such as ceramic and designed to fit compatibly with the shape and features of the intake air heating element 22 along a second surface 26. The first insulating part 23 is enclosed in a first housing 27 which may be a ‘c-shaped’ ramp housing as shown in detail in FIG. 2A. The first insulating part 23 is supported by a first ramp 28 and is held in place by a folded first top end 29 of the first housing 27. A first spring 30, which may be a wavy spring, is affixed between the first insulating part 23 and the first folded top end 29. Similarly, the second insulating part 26 is enclosed in a second housing 31, which may be a ‘c-shaped’ ramp housing. The second insulating part 26 is supported by a second ramp 32 and is held in place by a second folded top end 33 of the second housing 31. A second spring 34, which may be a wavy spring, is affixed between the second insulating part 25 and the second folded top end 33. When the intake air heater 19 is activated, the first wavy spring 30 and the second way spring 34 allow for thermal expansion of the intake air heating element 22 from heat generated during activation. This would ensure that there is no buckling of the at least two parallel configurations of the intake air heating element 22. Buckling may cause the at least two parallel configurations of the intake air heating element 22 to touch each other which would cause failure of the intake air heating element 22 through a power surge or short circuit. A third end of the intake air heating element 22 is bolted into the engine mixer 16 using a bolt 35. A fourth end of the intake air heating element 22 has a bolt 36 that is connected to a source of electricity such as a wire (not shown). The bolt 35 attached to the third end of the intake air heating element 22 is used as a ground connection. Electricity is converted into heat by the intake air heating element 22. Recirculated exhaust gas 20 carries with it soot and other particles. Since the intake air heater 19 is in the path of the exhaust gas 20, the soot collects in a first area 37 and a second area 38 as highlighted in FIG. 2 and FIG. 4. As can be seen, the soot collects in between and around the first spring 30 and the second spring 34. This collection of soot in the first area 37 and second area 38 disables the ability of the first spring 30 and the second spring 38 to allow for any thermal expansion of the intake air heating element 22. When the intake air heater 19 is enabled under appropriate conditions, which may be determined by a measurement of a coolant temperature (not shown), the intake air heating element 22 heats up, starts expanding, and, since the intake air heating element 22 has no room to expand because of the presence of soot, the at least two parallel configurations of the intake air heating element 22 buckle. If the at least two parallel configurations of the intake air heating element 22 touch because of buckling, it would cause shorting and the intake air heater 19 would fail. The failure of the intake air heater 19 results in incomplete combustion during cold starting conditions, which negatively affects the engine and emissions. FIG. 5 demonstrates an embodiment of a solution to this failure mode.

As is shown in FIG. 5, the first spring 30 and the second spring 34 are each removed and replaced by a different material of a certain size and shape. In this embodiment, the first spring 30 is replaced by a first compliant material 39 that may be of rectangular shape and cross-section, such as a closed cell silicone sponge, operable to elastically respond to a force. Closed cell silicone sponge is a material that can withstand a large range of temperatures, and has compression properties similar to the first spring 30 and the second spring 34 used in the intake air heater 19 in the original embodiment. Similarly, the second spring 34 is replaced by a second compliant material 40, such as a closed cell silicone sponge, operable to elastically respond to a force. This may also be rectangular in shape and have a rectangular cross-section. The first compliant material, 39 has a first adhesive layer, 41 that may cover the entire area of a first surface 45 of the first compliant material 39, and is used to affix the first surface 45 of the first compliant material 39 to a first inner surface 43 of the first housing 27. Similarly, the second compliant material, 40, has a first adhesive layer 42 that may cover the entire area of a first surface 46 of the second compliant material 40, and may be used to affix the first surface 46 of the second compliant material, 40, to a first inner surface 44 of the second housing 31. The adhesive may be a material that can withstand high temperatures, that is up to 700 degree Fahrenheit. When the intake air heater 19 is enabled, the intake air heating element 19 will have room to expand through the compression of the first compliant material 39 and the second compliant material 40. Additionally, since the first compliant material 39 fills up a first area between and around the first insulating part 23, and the first housing 27 and the second compliant material, 40 fills up a second area between the second insulating part 25 and the second housing 31, there is relatively less room for the soot being carried in the exhaust gas 20 to be collected between the first insulating part 23 and the first housing 27 and between the second insulating part 25 and the second housing 31. Therefore, the intake air heating element 22 will not buckle when the intake air heater 19 is enabled.

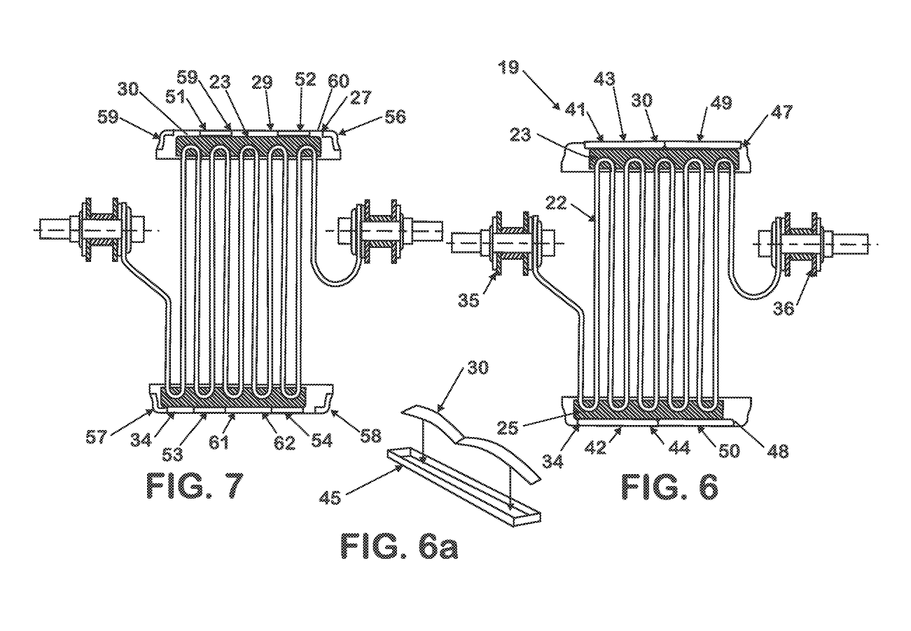

Referring now to FIG. 6 and FIG. 6A, a third embodiment of an intake air heater 19 is shown. In this embodiment, a first spring 30 is encased in a first hollow part, 47 as shown in detail in FIG. 6A, which may be made of a material such as closed cell silicone sponge. Another suitable material such as polytetrafluoroethylene and the like may also be used. While polytetrafluoroethylene material is stiff compared to the closed cell silicone sponge, the relatively soft surface of the polytetrafluoroethylene material along with its positioning will reduce soot from collecting within the intake air heater 19. A second spring, 34 is encased in a second hollow part 48, which may be made from closed cell silicone sponge or any other suitable material such as polytetrafluoroethylene and the like. Both the first hollow part 47 and the second hollow part 48 may be of a rectangular shape. A first surface 49 of the first hollow part 47 has a first adhesive layer 41, which may be of the same shape and area as first surface 49, to affix the first hollow part 47 to the first inner surface 43 of the first housing 29. Similarly, a first surface 50 of the second hollow part 48 has a second adhesive layer 42, which may be of the same shape and area as the first surface 50 to affix the second hollow part 48 to the first inner surface 44 of the second housing 31. This embodiment combines the benefit of the wavy spring along with the protection, elasticity and flexibility of the closed cell silicone sponge, since the closed cell silicone sponge can block any open areas that are prone to soot collection as highlighted in the original embodiment.

FIG. 7 shows a fourth embodiment of the intake air heater 19. In this embodiment, a first spring, 30, which may be a wavy spring, is placed between a first insulating part 23 and a first folded top end 29 of a first housing 27. A first piece of rectangular cross-section 51, that may be made of a material like a closed cell silicone sponge is fixed between a first wavy portion 59 of the first wavy spring 30 and a second piece of a rectangular cross-section, 52, that may be made of a material like a closed cell silicone sponge is fixed between a second wavy portion 60 of the first spring 30 and the first inner surface 43 of the first housing 29. Additionally, a third piece of rectangular cross-section 53, that may be made of a material such as a closed cell silicone sponge is fixed onto the first inner surface 43 of the first folded top end 29 and a fourth piece of rectangular cross-section 54, that may be made of a material such as a closed cell silicone sponge is fixed onto the first inner surface 43 of the first folded top end 29 on the opposing end as shown in FIG. 7. The spring like properties of the first piece of rectangular cross section 51, the second piece of rectangular cross section 52, the third piece of rectangular cross-section 53 and the fourth piece of rectangular cross-section 54 allow for the flattening of the first spring 30 without significant hindrance, while simultaneously preventing accumulation of soot by covering critical open areas such as those highlighted in FIG. 4. Similarly, a fifth piece of rectangular cross-section 55, and a sixth piece of rectangular cross-section 56, placed between the second spring, 34 and the second housing 31, prevent accumulation of soot between the second insulating part 25 and the second housing 31 while allowing for the flexibility of the second spring 34 and a seventh piece of rectangular cross-section 57 and an eighth piece of rectangular cross-section 58, affixed to either end of the folded top end 33 of the second housing 33 prevent accumulation of soot between the second insulating material 25 and the second housing 31. Other shapes and cross-sections of the closed cell silicone sponge may be possible for similar implementation and effect.

What is claimed is:

1. An intake air heater for use with an internal combustion engine, said intake air heater comprising:
an intake air heating element for heating intake manifold air;
a first insulating part with a first surface for securing a first end of the intake air heating element and a second insulating part with a second surface for securing a second end of the intake air heating element;
a first housing with a first ramp and a first folded top end to secure the first insulating part and a second housing with a second ramp and a second folded top end to secure the second insulating part, wherein;
a first compliant material operable to elastically respond to a force applied to it is placed between a first surface of the first insulating part and a first inner surface of the first housing; and
a second compliant material operable to elastically respond to a force applied to it is placed between a first surface of the second insulating part and a first inner surface of the second housing.

2. The air intake of claim 1, wherein the first compliant material and the second compliant material are closed cell silicone foam.

3. The intake air heater of claim 1, wherein the intake air heating element is a rectangular shaped ribbon heating element with at least two folds, arranged in a parallel configuration.

4. The intake air heater of claim 1, wherein the first insulating part and the second insulating part are made of ceramic.

5. The intake air heater of claim 1, wherein the first housing and the second housing are made of aluminum.

6. The intake air heater of claim 1, wherein the first compliant material and the second compliant material have a rectangular cross section.

7. The intake air heater of claim 1, wherein the intake air heating element expands when it is electrically enabled.

8. The intake air heater of claim 1, wherein the first compliant material and the second compliant material compress when the intake air heating element expands.
